(19) United States
(12) Patent Application Publication
(10) Pub. No.: US 2007/0127327 A1
(43) Pub. Date: Jun. 7, 2007

(54) Objective lens actuator and information recording/playback apparatus

(76) Inventors: Makoto Nagasato, Yokohama-Shi (JP); Kenya Kurokawa, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/635,408

(22) Filed: Dec. 6, 2006

(30) Foreign Application Priority Data
Dec. 6, 2005 (JP) 2005-351634

(51) Int. Cl. G11B 7/00

(52) U.S. Cl. 369/44.15; 369/44.32

(57) ABSTRACT

An objective lens actuator according to the present invention includes: an objective lens; a lens holder that fixes the objective lens; a pair of tracking coils; a pair of radial tilt coils; a pair of focus coils superimposed and attached to the radial tilt coils; a pair of tracking magnets disposed so as to face the tracking coils; and a pair of the focus magnets disposed so as to face the focus coils. The pair of the focus coils and the pair of the focus magnets are each asymmetric in at least one of shape, size, mass, and location, and each have balanced moments about the radial tilt axis.

### CROSS-REFERENCE TO RELATED APPLICATIONS

This application claims the benefit of priority of Japanese Patent Application No. 2005-351634, filed Dec. 6, 2005, the entire contents of which are incorporated herein by reference.

### BACKGROUND

1. Field

The present invention relates to objective lens actuators and information recording/playback apparatuses, and particularly relates to an objective lens actuator that drives an objective lens of an optical pickup in three axis directions, and an information recording/playback apparatus having the objective lens actuator built therein.

2. Description of the Related Art

In recent years, as is well known, high-density information recording has been promoted, and an optical disc having a storage capacity as large as 4.7 GB (gigabyte) on a single side thereof, has been put into practical use.

For example, such an optical disc may be a CD (Compact Disk)-ROM (Read Only Memory), DVD (Digital Versatile Disk)-ROM, DVD-R (Recordable), DVD-RW (ReWritable), DVD-RAM (Random Access Memory), HD (High Definition)-DVD, or the like.

The information recording/playback apparatus of the optical disc records or plays back information by precisely positioning a focal point of laser light in a specific position on the optical disc. The positioning works by controlling a relative position or a relative attitude angle of an objective lens for condensing the laser light, in relation to the optical disc, by using the objective lens actuator.

In particular, position controls called tracking control and focus control, and attitude angle control called radial tilt control are performed with the use of servo mechanisms.

The tracking control is realized by servo control that finely adjusts the position of the objective lens in the radial direction such that the focal point of the laser light is constantly located at the center of a specific track of the optical disc. The focus control is realized by servo control that controls a separation between the objective lens and the optical disc such that the focal point of the laser light is precisely located on an information-recording surface of the optical disc.

The radial tilt control is realized by servo control that controls an attitude angle of the objective lens to be along the radial direction of the optical disc such that the laser light constantly perpendicularly irradiates a reflection surface of the optical disc even when the reflection surface of the optical disc is slightly shifted from a plane perpendicular to an optical axis of the laser light and inclined in a radial tilt direction.

Generally, each servo control is driven according to an electromagnetic forces caused by currents of coils and magnetic fluxes of permanent magnets. Accordingly, each coil and each permanent magnet are disposed at a movable section on which the objective lens is mounted and at a fixture section which supports the movable section such that the coil and the permanent magnet are adjacent to each other.

In addition, the objective lens actuator must be capable of tracking the optical disc rotating at high speed, and thus, the servo control system needs to be highly responsive. Namely, the servo system needs to cover a wide frequency band.

JP-A 63-259842 discloses an objective lens actuator that allows an objective lens to track an optical disc rotating at high speed. However, this Japanese Publication only discloses a configuration to drive the objective lens in two axis directions, namely, a focus direction and a tracking direction, and therefore, the configuration is not suitable for the practical use of existing highly precise objective lens actuators, which require the control in a radial tilt direction.

In contrast, US 2003/0016597 A1 discloses an objective lens actuator that drives an objective lens in three axis directions, namely, the focus direction, tracking direction, and radial tilt direction, the actuator being small and enabling high sensitivity in driving.

To transfer information at high rate in an optical disc drive, a high-order resonance frequency at the movable section of the objective lens actuator is must be increased, in addition to increase in thrust of the objective lens actuator. However, according to this US Publication, the structural rigidity of the movable section is small, and thus, the high-order resonance frequency cannot be increased.

For instance, the performance of the objective lens actuator disclosed in the US Publication is disclosed by Junya Aso et al., in “High Response Actuator with Tilt Function for 12.7 mm Slim Optical Disc Drives”, ISOM/ODS (joint International Symposium on Optical Memory and Optical Data Storage) 2002, p. 326-328. Referring to this, since the high-order resonance frequency is as low as 20 kHz, it is obvious that the configuration is not suitable for the practical use with respect to the performance level of recently developed objective lens actuators.

Recently, information equipment having an information recording/playback apparatus built therein, for instance, a personal computer, markedly tends to be small and thin. In line with this trend, the demand for decreases in weight and thickness and dense package of the information recording/playback apparatus, or the objective lens actuator mounted therein, is further increasing.

At the same time, in order to secure the basic function and performance of the objective lens actuator, the coils and permanent magnets need to be arranged in a well-balanced manner. In addition, it is also necessary to secure a mechanism for supporting the movable section, to which the objective lens is attached, and a path of the laser light. Upon these restrictions, the key design issue is how to densely package the objective lens actuator.

Also, when decreasing the weight and thickness of the objective lens actuator, the rigidity of a frame member of the objective lens actuator tends to be decreased, and this may disadvantageously affects the high-order resonance of the servo control system. Therefore, it is also important to secure the rigidity of the frame member while making the actuator lighter and thinner.

### SUMMARY OF THE INVENTION

In light of the above-mentioned circumstances, an object of the present invention is to provide an objective lens actuator that may be densely packaged and reduced in weight and thickness while securing basic function and performance of the objective lens actuator and high-order resonance resistance of a servo control system thereof, and to provide an information recording/playback apparatus having the objective lens actuator built therein.

For solving the above-mentioned problems, according to an aspect of the present invention, an objective lens actuator capable of translational driving in a tracking direction, translational driving in a focus direction, and rotational driving about a radial tilt axis, includes: an objective lens for condensing laser light on an information-recording surface of an optical disc; a lens holder shaped in a hollow, substantially rectangular parallelepiped, for fixing the objective lens at the center of an upper surface of the lens holder; a pair of tracking coils, attached at lateral surfaces of the lens holder diagonally with the objective lens being interposed between the tracking coils, for translationally driving the lens holder in the tracking direction; a pair of radial tilt coils, attached at the lateral surfaces of the lens holder at positions different from that of the tracking coils diagonally about the radial tilt axis with the objective lens being interposed between the radial tilt coils, for rotationally driving the lens holder about the radial tilt axis; a pair of focus coils, superimposed and attached onto the radial tilt coils, for translationally driving the lens holder in the focus direction; a pair of tracking magnets disposed so as to face the tracking coils; a pair of focus magnets disposed so as to face the focus coils; a fixture section at which the tracking magnets and the focus magnets are fixed; and a suspension wire for holding the lens holder in the air, an end of the suspension wire being fixed at the fixture section and the other end thereof being fixed at the lens holder. The pair of the focus coils and the pair of the focus magnets, disposed with the radial tilt axis being interposed between the coils and between the magnets, are each asymmetric in at least one of shape, size, mass, and location, and each have balanced moments about the radial tilt axis.

In addition, for solving the above-described problems, according to another aspect of the invention, an information recording/playback apparatus, includes: an optical pickup having an objective lens actuator; a drive controller that controls driving of the objective lens actuator; a playback processor that performs a playback processing for a signal output from the optical pickup; and a recording processor that modulates recording data into a laser control signal, and outputs the laser control signal to the optical pickup. The objective lens actuator capable of translational driving in a tracking direction, translational driving in a focus direction, and rotational driving about a radial tilt axis, includes: an objective lens for condensing laser light on an information-recording surface of an optical disc; a lens holder shaped in a hollow, substantially rectangular parallelepiped, for fixing the objective lens at the center of an upper surface of the lens holder; a pair of tracking coils, attached at lateral surfaces of the lens holder diagonally with the objective lens being interposed between the tracking coils, for translationally driving the lens holder in the tracking direction; a pair of radial tilt coils, attached at the lateral surfaces of the lens holder at positions different from that of the tracking coils diagonally about the radial tilt axis with the objective lens being interposed between the radial tilt coils, for rotationally driving the lens holder about the radial tilt axis; a pair of focus coils, superimposed and attached to the radial tilt coils, for translationally driving the lens holder in the focus direction; a pair of tracking magnets disposed so as to face the tracking coils; a pair of focus magnets disposed so as to face the focus coils; a fixture section at which the tracking magnets and the focus magnets are fixed; and suspension wire for holding the lens holder in the air, an end of the suspension wire being fixed at the fixture section and the other end thereof being fixed at the lens holder. The pair of the focus coils and the pair of the focus magnets, disposed with the radial tilt axis being interposed between the coils and between the magnets, are each asymmetric in at least one of shape, size, mass, and location, and each have balanced moments about the radial tilt axis.

With these configurations according to the present invention, the objective lens actuator and the information recording/playback apparatus may be densely packaged and reduced in weight and thickness while securing basic function and performance of the objective lens actuator and high-order resonance resistance of a servo control system thereof.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an exemplary configuration of an information recording/playback apparatus according to an embodiment of the present invention;

FIG. 2 is an external perspective view showing an exemplary configuration of an objective lens actuator viewed from the front according to a first embodiment of the present invention;

FIG. 3 is an external perspective view showing the exemplary configuration of the objective lens actuator viewed from the back according to the first embodiment of the present invention;

FIG. 4 is an exploded perspective view showing the exemplary configuration of the objective lens actuator according to the first embodiment;

FIG. 5 is a perspective view showing an attachment relationship between a lens holder and driving coils;

FIG. 6 is a perspective view illustrating a positional relationship between magnets and the driving coils;

FIG. 7 is a plan view illustrating the positional relationship between the magnets and the driving coils;

FIG. 8 is a plan view showing the objective lens actuator according to the first embodiment;

FIG. 9 is a perspective view illustrating an arrangement of a raising mirror;

FIG. 10 is a perspective view illustrating a positional relationship between the raising mirror and an objective lens;

FIG. 11 is a perspective view illustrating an arrangement relationship between a lens holder and the raising mirror;

FIG. 12 is a front elevational view illustrating a positional relationship between a semicircular cutout and a reinforcing projection of the lens holder;

FIG. 13 is a perspective view illustrating the positional relationship between the semicircular cutout and the reinforcing projection of the lens holder;

FIG. 14 is a perspective view showing a structure of the lens holder viewed from the bottom surface side;

FIG. 15 is a plan view showing a configuration of an objective lens actuator according to a second embodiment;

FIG. 16 is a perspective view showing the objective lens actuator viewed from the upper front according to the second embodiment; and

FIG. 17 is a perspective view showing the objective lens actuator viewed from the lower front according to the second embodiment.

### DETAILED DESCRIPTION

Embodiments of an objective lens actuator and an information recording/playback apparatus according to the present invention will be described below with reference to the attached drawings.

(1) Configuration and Operation of Information Recording/playback Apparatus

An information recording/playback apparatus 100 according to an embodiment records/plays back information on/from an optical disc 200, such as a CD-R, CD-RW, DVD-R, DVD-RW, DVD-RAM, HD DVD-ROM, HD DVD-R, HD DVD-RW, or HD DVD-RAM.

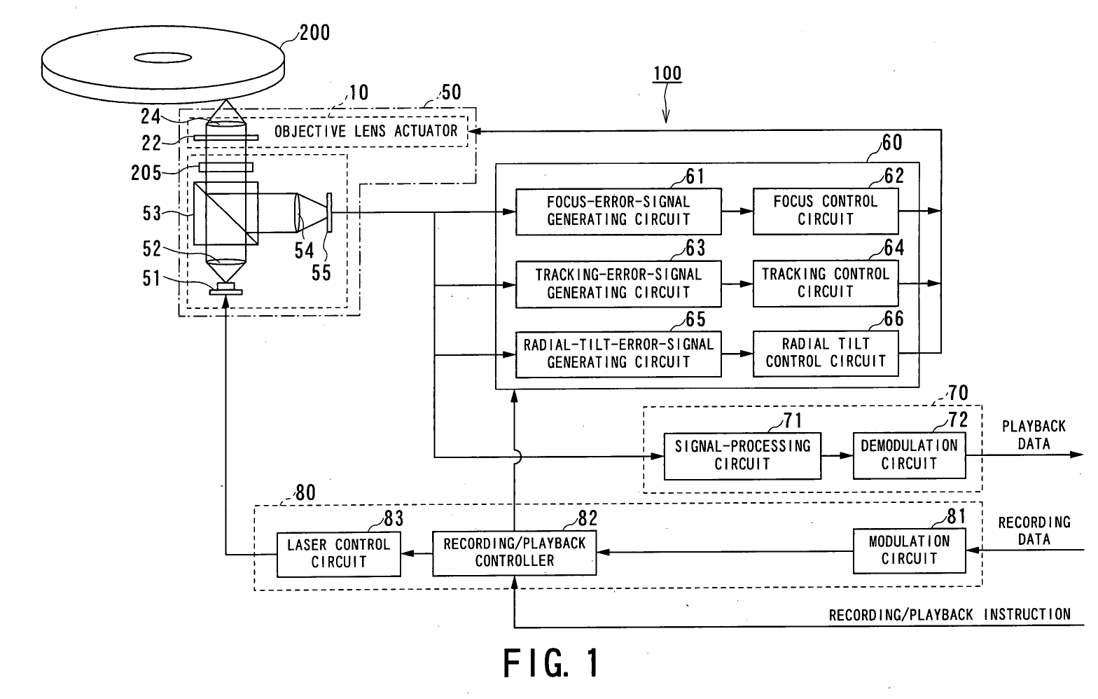

FIG. 1 is an illustration showing an exemplary configuration of the information recording/playback apparatus 100.

The information recording/playback apparatus 100 includes an optical pickup 50, a three-axis controller 60 (drive controller), a playback processor 70, and a recording processor 80.

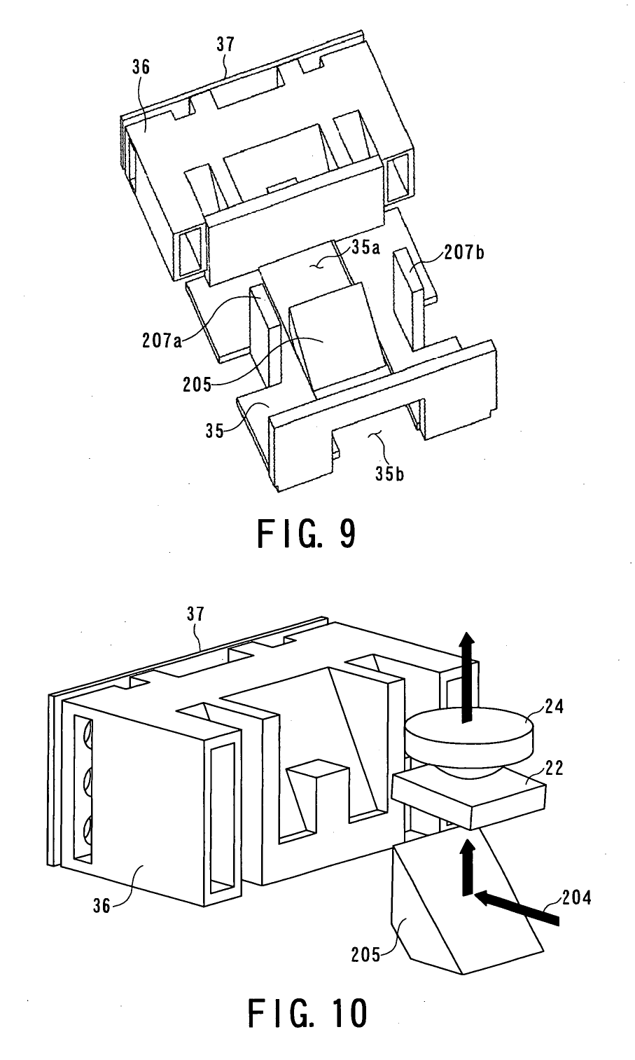

The optical pickup 50 emits laser light on the optical disc 200 for recording/playing back information, and converts reflection light from the optical disc 200 into electric signals to output the electric signals as playback signals. The optical pickup 50 includes, as components for its optical system, a semiconductor laser 51, a collimator lens 52, a PBS (polarizing beam splitter) 53, a diffraction grating with a quarter-wave plate 22, an objective lens 24, a condenser lens 54, and an optical detector 55. A raising mirror 205 (see FIG. 9 and the like), for redirecting the laser light, may be disposed between the PBS 53 and the diffraction grating with the quarter-wave plate 22.

In addition, the optical pickup 50 includes an objective lens actuator 10 on which the objective lens 24 and the diffraction grating with the quarter-wave plate 22 are mounted. The objective lens actuator 10 controls driving of the objective lens 24 and that of the diffraction grating with the quarter-wave plate 22 in three axis directions.

The three-axis controller 60 includes a focus-error-signal generating circuit 61, a focus control circuit 62, a tracking-error-signal generating circuit 63, a tracking control circuit 64, a radial-tilt-error-signal generating circuit 65, and a radial tilt control circuit 66.

Control signals are generated by these circuits of the three-axis controller 60 and are output to the objective lens actuator 10 to control the position and the attitude angle of the objective lens 24. In particular, the three-axis controller 60 servo controls focus control that controls a separation between the objective lens and the optical disc such that the focal point of the laser light is precisely located on the optical disc; tracking control that finely adjusts the position of the objective lens in the radial direction such that the focal point of the laser light is constantly located at the center of a specific track of the optical disc; and radial tilt control that controls an attitude angle of the objective lens to be along the radial direction of the optical disc such that the laser light constantly perpendicularly irradiates the reflection surface of the optical disc even when the reflection surface of the optical disc is slightly shifted from a plane perpendicular to an optical axis of the laser light and inclined in the radial tilt direction.

The playback processor 70 performs a playback processing for the signals output from the optical pickup 50, and includes a signal-processing circuit 71 and a demodulation circuit 72.

The recording processor 80 mainly records information on the optical disc 200, and includes a modulation circuit 81, a recording/playback controller 82, and a laser control circuit 83.

The operation of the information recording/playback apparatus 100 thus-configured will be described. The description starts with the operation of recording information on the optical disc 200.

The modulation circuit 81 of the recording processor 80 modulates recording information (data symbol) provided by a host, for example, a main body of a personal computer, into a channel bit series on the basis of a predetermined modulation system. The channel bit series corresponding to the recording information is input to the recording/playback controller 82.

To the recording/playback controller 82, a recording/playback instruction (in this case, a recording instruction) sent from the host is input. The recording/playback controller 82 outputs the control signals to the three-axis controller 60 to drive the objective lens actuator 10 so that the light beam is properly condensed at a target recording position. In addition, the recording/playback controller 82 applies the channel bit series to the laser control circuit 83.

The laser control circuit 83 converts the channel bit series into a laser driving waveform, so that the semiconductor laser 51 is pulse driven. As a result, the semiconductor laser 51 generates recording light beam corresponding to a desired bit series.

The recording light beam generated by the semiconductor laser 51 is parallelized by the collimator lens 52 to be parallel light, enters the PBS 53, and passes through it. The light beam transmitted through the PBS 53 passes through the diffraction grating with the quarter-wave plate 22, and condensed on the information-recording surface of the optical disc 200 by way of the objective lens 24.

The condensed recording light beam is maintained in a condition where the optimum light beam spot is provided on the information-recording surface of the optical disc 200, in accordance with the focus control, tracking control, and radial tilt control performed by the three-axis controller 60 and the objective lens actuator 10.

Then, information playback from the optical disc 200 by the information recording/playback apparatus 100 will be described.

To the recording/playback controller 82, a recording/playback instruction (in this case, a playback instruction) sent from the host is input. The recording/playback controller 82 outputs playback control signals to the laser control circuit 83 on the basis of the playback instruction sent from the host.

The laser control circuit 83 drives the semiconductor laser 51 on the basis of the playback control signals to generate playback light beam. The playback light beam generated by the semiconductor laser 51 is parallelized by the collimator lens 52 to be parallel light, enters the PBS 53, and passes through it. The light beam transmitted through the PBS 53 passes through the diffraction grating with the quarter-wave plate 22, and condensed on the information-recording surface of the optical disc 200 by way of the objective lens 24.

The condensed playback light beam is maintained in the condition where the optimum light beam spot is provided on the information-recording surface of the optical disc 200, in accordance with the focus control, tracking control, and radial tilt control by the three-axis controller 60 and the objective lens actuator 10.

The playback light beam irradiating the optical disc 200 is reflected by a reflection film or a reflective recording film provided in the information-recording surface. The reflection light is parallelized to be parallel light again when passing through the objective lens 24 in the inverse direction, passes through the diffraction grating with the quarter-wave plate 22, and then is reflected by the PBS 53 which allows light perpendicular to the incident light to pass therethrough.

The light beam reflected by the PBS 53 is condensed by the condenser lens 54 to be convergent light, and incident on the optical detector 55. The optical detector 55 includes, for instance, a photodetector divided into four elements. The light beam incident on the optical detector 55 is photoelectrically converted into electric signals and the electric signals are amplified. The amplified signals are equalized by the signal-processing circuit 71 of the playback processor 70 and binarized, and then are sent to the demodulation circuit 72. The demodulation circuit 72 demodulates the signals in accordance with a predetermined modulation system, so that playback data is output.

Meanwhile, a part of the electric signals output from the optical detector 55 are input to the three-axis controller 60, and the focus-error signal-generating circuit 61 generates focus-error signals. Similarly, a part of the electric signals output from the optical detector 55 are input to the three-axis controller 60, and the tracking-error-signal generating circuit 63 and the radial-tilt-error-signal generating circuit 65 generate tracking-error signals and radial-tilt-error signals, respectively.

The focus control circuit 62 controls the objective lens actuator 10 on the basis of the focus-error signals, to control focus of a beam spot. The tracking control circuit 64 controls the objective lens actuator 10 on the basis of the tracking-error signals, to control tracking of the beam spot. The radial tilt control circuit 66 controls the objective lens actuator 10 on the basis of the radial-tilt-error signals, to control radial tilt of the beam spot.

As described above, the objective lens actuator 10 controls the position and the attitude angle of the objective lens 24 mounted in the objective lens actuator 10 on the basis of the control signals sent from the three-axis controller 60, so that the position of the beam spot is maintained to be optimum relative to the optical disc 200.

Then, a configuration and operation of the objective lens actuator 10 (first embodiment) will be described.

(2) Configuration and Operation of Objective Lens Actuator (Part I)

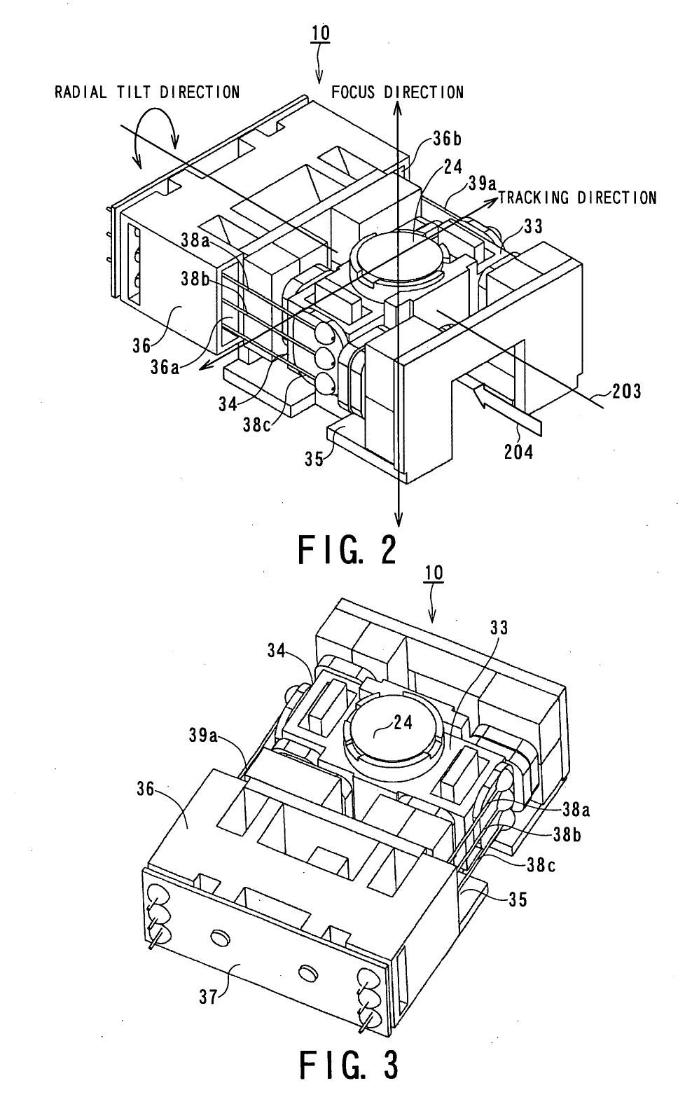

FIGS. 2 and 3 each show an external perspective view of the overall configuration of the objective lens actuator 10. FIG. 2 is a perspective view seen in an incident light direction of light beam 204 (hereinafter, a side from which the light beam 204 is incident is referred to as the front, a side opposite thereto is referred to as the back, the right side seen from the front is referred to as the right, and the left side seen from the front is referred to as the left). FIG. 3 is a perspective view showing the objective lens actuator 10 seen from the back.

The objective lens actuator 10 allows a movable section 34 including a lens holder 33 that holds the objective lens 24 to be translationally driven in a focus direction, translationally driven in a tracking direction, and rotationally driven about a radial tilt axis 203 (in a radial tilt direction), individually with respect to the information-recording surface of the optical disc 200.

A fixture section (see FIG. 9) supporting the movable section 34 includes a yoke base 35, a damping holder 36 that is disposed at the back of the yoke base 35 and formed substantially in a rectangular parallelepiped, a fixed-end circuit board 37 that is fixed at the back of the damping holder 36, and the like.

The damping holder 36 has openings 36a and 36b at both sides. The fixed-end circuit board 37 is attached at the back of the damping holder 36 (see FIG. 3). The fixed-end circuit board 37 is connected to output terminals of the focus control circuit 62, the tracking control circuit 64 and the radial tilt control circuit 66 of the three-axis controller 60.

In the fixed-end circuit board 37, ends of three suspension wires 38a, 38b, and 38c, which are resilient linear substances, are vertically aligned in the focus direction and fixed at positions corresponding to the opening 36a of the damping holder 36. These suspension wires 38a, 38b and 38c are made of an electrically conductive material, and other ends of these penetrate through the opening 36a of the damping holder 36, reach substantially the center of the yoke base 35, and are fixed at the movable section 34.

In addition, in the fixed-end circuit board 37, ends of three suspension wires 39a, 39b, and 39c (in FIGS. 2 and 3, the wires 39b and 39c are not shown) are vertically aligned in the focus direction and fixed at positions corresponding to the opening 36b of the damping holder 36. These suspension wires 39a, 39b and 39c are made of an electrically conductive material, and other ends of these penetrate through the opening 36b of the damping holder 36, reach substantially the center of the yoke base 35, and are fixed at the movable section 34.

The movable section 34 is supported between the other ends of the three suspension wires 38a, 38b, and 38c and the other ends of the three suspension wires 39a, 39b, and 39c.

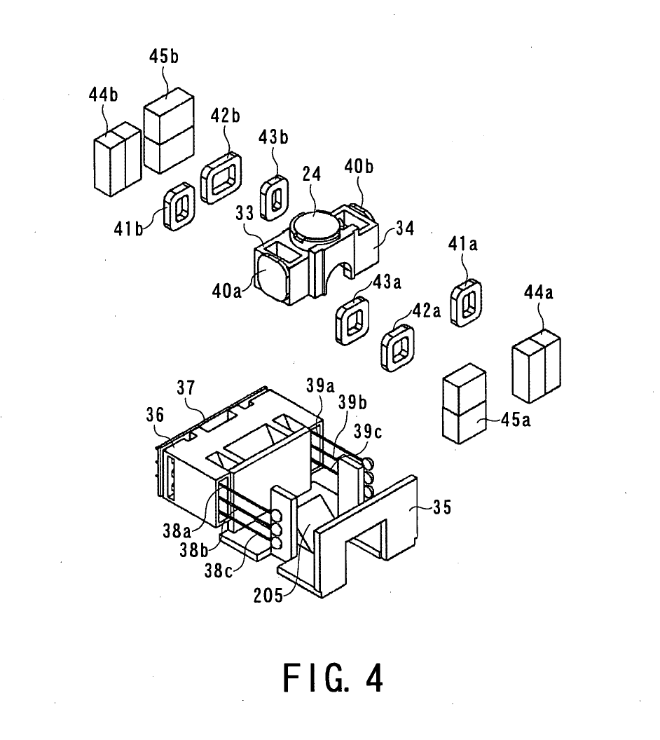

FIG. 4 is an exploded perspective view in which the components of the objective lens actuator 10 are exploded and illustrated.

As shown in FIG. 4, the movable section 34 is formed substantially in a rectangular parallelepiped, and the lens holder 33 that holds the objective lens 24 on its upper surface shown in the drawing is attached to the movable section 34. In addition, the movable section 34 has movable-end circuit boards 40a and 40b attached on the left and right side walls of the movable section 34.

The other ends of the suspension wires 38a, 38b, and 38c are connected to the movable-end circuit board 40a by soldering or the like. Similarly, the other ends of the suspension wires 39a, 39b, and 39c are connected to the movable-end circuit board 40b by soldering or the like. Upon this connection, the movable section 34 is supported resiliently in the air with respect to the yoke base 35, and this connection allows the movable section 34 to be translationally driven in the tracking and focus directions and rotationally driven about the radial tilt axis 203.

The openings 36a and 36b of the damping holder 36 are filled with a viscoelastic material, for instance, silicone gel, to give high damping characteristics to the suspension wires 38a to 38c, and 39a to 39c.

In addition, a tracking coil 41a is attached to the front side wall at the right part of the movable section 34, and a focus coil 42a and a radial tilt coil 43a are attached to the front side wall at the left part thereof. Note that the focus coil 42a and the radial tilt coil 43a are attached to be superimposed.

A focus coil 42b and a radial tilt coil 43b are superimposed and attached to a back side wall at the right part of the movable section 34, and a tracking coil 41b is attached to the back side wall at the left part.

The coils 41a to 43a, and 41b to 43b are electrically connected to the movable-end circuit boards 40a and 40b, respectively, so that the control current output from the three-axis controller 60 is applied to the coils 41a to 43a, and 41b to 43b from the movable-end circuit boards 40a and 40b through the fixed-end circuit board 37 and the suspension wires 38a to 38c, and 39a to 39c.

In the yoke base 35, tracking magnets 44a and 44b and focus magnets 45a and 45b are disposed and fixed such that the tracking magnet 44a opposes the tracking magnet 44b, and the focus magnet 45a opposes the focus magnet 45b, respectively, diagonally about the objective lens 24, and at predetermined distances from the tracking coils 41a and 41b, and the focus coils 42a and 42b.

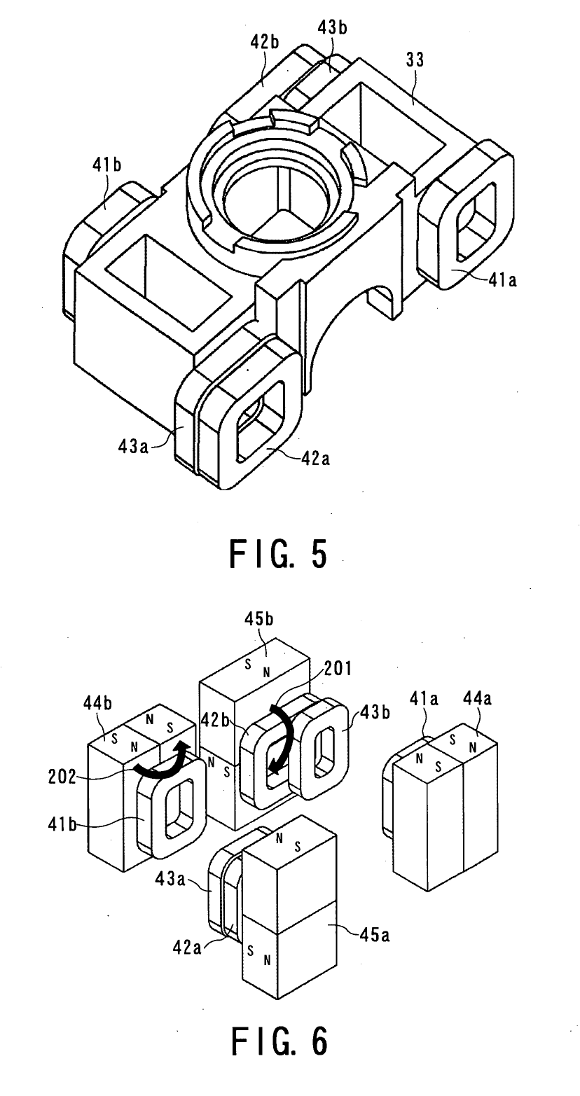

FIG. 5 illustrates a positional relationship between the lens holder 33, which is a frame member of the movable section 34, and the tracking coils 41a and 41b, the focus coils 42a and 42b, and the radial tilt coils 43a and 43b attached to the lens holder 33. As described above, the tracking coils 41a and 41b are attached to the lens holder 33 diagonally about the objective lens 24. Also, the focus coils 42a and 42b, and the radial tilt coils 43a and 43b are attached to the lens holder 33 diagonally, at positions opposite to those of the tracking coils 41a and 41b.

FIG. 6 illustrates an example of a positional relationship between the coils and the magnets facing the coils, with polarities of the magnets taken into account.

The tracking magnets 44a and 44b are formed by joining two magnets in a left and right direction such that a N-pole is adjacent to a S-pole in the tracking direction (left and right direction shown in FIG. 6). As a result, magnetic flux is generated from the N-pole of the left magnet toward the S-pole of the right magnet, and the tracking coils 41a and 41b are disposed in this magnetic flux. Accordingly, an electromagnetic force is generated between the magnetic flux and the current applied to the tracking coils 41a and 41b, and this electromagnetic force allows the lens holder 33, to which the tracking coils 41a and 41b are attached, to be translationally driven in the tracking direction. In this case, the current is applied to the tracking coils 41a and 41b disposed diagonally so that the electromagnetic force is generated in the same direction.

The focus magnets 45a and 45b are formed by joining two magnets in a vertical direction such that a N-pole is adjacent to a S-pole in the focus direction (vertical direction shown in FIG. 6). As a result, magnetic flux is generated from the N-pole of the upper magnet toward the S-pole of the lower magnet, and the focus coils 42a and 42b and the radial tilt coils 43a and 43b are disposed in this magnetic flux. An electromagnetic force is generated between the magnetic flux and the current applied to the focus coils 42a and 42b and to the radial tilt coils 43a and 43b.

At this time, the current is applied to the focus coils 42a and 42b so that the electromagnetic force is generated in the same direction (upward or downward). Accordingly, a resultant force of the electromagnetic forces respectively generated at the focus coils 42a and 42b allows the lens holder 33 to be translationally driven in the focus direction.

On the other hand, the current is applied to the radial tilt coils 43a and 43b so that the electromagnetic forces are generated in the directions opposite to each other. Accordingly, such current application allows the lens holder 33 to be rotationally driven about the radial tilt axis 203 disposed between the radial tilt coils 43a and 43b.

It should be noted that the direction of the polarities of the magnets are not limited to the example shown in FIG. 6, and it is obvious that a configuration in which the N-pole and S-pole are reversed may be conceivable. In this case, the direction of the current applied to the corresponding coils may be changed appropriately.

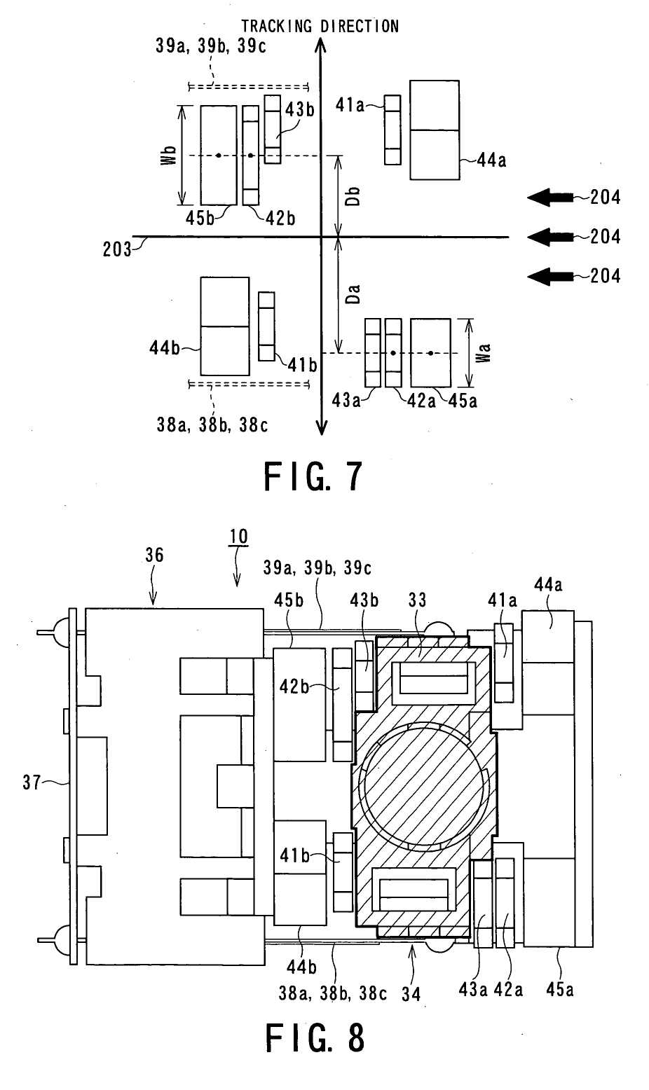

FIG. 7 is a plan view showing a positional relationship among the focus magnets 45a and 45b, the tracking magnets 44a and 44b, the focus coils 42a and 42b, the radial tilt coils 43a and 43b, and the tracking coils 41a and 41b. FIG. 7 also illustrates the radial tilt axis 203, light beam 204, and the suspension wires.

FIG. 8 is a plan view showing the objective lens actuator 10 including other components in addition to the magnets and the coils.

As shown in FIGS. 7 and 8, each pair of the focus magnets 45a and 45b, the focus coils 42a and 42b, and the radial tilt coils 43a and 43b, being disposed diagonally about the objective lens 24, is different in shape, size, and location. Namely, each pair is asymmetric about the radial tilt axis 203 (Wa ≠ Wb, Da ≠ Db, and the like). Herein, the radial tilt axis 203 is a rotation axis in the radial tilt direction, and allows the six suspension wires 38a, 38b, 38c, 39a, 39b, and 39c to be axisymmetric about the axis.

Assuming that there is no physical restriction in mounting, it is the simplest and dynamically-well-balanced configuration that each pair of the magnets and the coils is symmetric in shape, size, and location about the radial tilt axis 203 with the objective lens 24 being interposed therebetween.

However, as densely packaging the objective lens actuator 10 under various physical restrictions, the shape, size, and location of the magnets and coils inevitably become asymmetric about the radial tilt axis 203.

Accordingly, in the present embodiment, as shown in FIGS. 7 and 8, the focus coil 42b, radial tilt coil 43b, and tracking coil 41b, attached at the back of the lens holder 33, as well as the facing focus magnet 45b, and tracking magnet 44b, are disposed close to the radial tilt axis 203 disposed at the center so as not to interfere with the six suspension wires.

In contrast, the focus coil 42a, radial tilt coil 43a, and tracking coil 41a, attached at the front of the lens holder 33, as well as the facing focus magnet 45a, and tracking magnet 44a, are disposed away from the radial tilt axis 203 disposed at the center so as not to interfere with the light beam 204.

To meet the symmetric property in the arrangement while securing the path of the light beam 204, the distance between both sides of suspension wires must be increased, and accordingly, downsizing and dense package may not be achieved. Therefore, according to the present embodiment, a priority is given to the downsizing and dense package, and a dynamically imbalanced configuration is compensated correspondingly.

In particular, the size, shape, and the like, of the focus coils 42a and 42b, the focus magnets 45a and 45b are determined such that the objective lens 24 does not inclined in the radial tilt direction, when the same current is applied to the pair of focus coils 42a and 42b and the objective lens 24 is driven in the focus direction, i.e., the moments in each pair about the radial tilt axis 203 are balanced.

To be more specific, for instance, the sizes of the focus coil 42b and the focus magnet 45b disposed at the back side are determined larger than those of the focus coil 42a and the focus magnet 45a disposed at the front side, so that the larger electromagnetic force is generated at the back to compensate the difference in the distances (Da>Db) relative to the radial tilt axis 203.

Alternatively, the focus coil 42a and the focus magnet 45a at the front may respectively have the equivalent sizes as that of the focus coil 42b and the focus magnet 45b at the back, and the current ratio of the focus coil 42a to the focus coil 42b may be varied such that the electromagnetic force at the back becomes larger than that at the front, thereby balancing the moments about the radial tilt axis 203.

In the objective lens actuator 10 thus-configured, when the current is applied to the focus coils 42a and 42b, the electromagnetic forces in the focus direction act on both of the focus coils 42a and 42b. Due to the electromagnetic forces, the objective lens 24 attached to the movable section 34 is translationally driven in the focus direction (optical axis direction of the objective lens 24). At this time, since the moments about the radial tilt axis 203 respectively generated at the focus coils 42a and 42b are equivalent and act in opposite directions, the moments are canceled with each other, and the objective lens 24 would not be inclined in the radial tilt direction.

In view of rotationally driving the objective lens 24 in the radial tilt direction, for instance, the control current is applied to the radial tilt coil 43b such that the electromagnetic force is generated in the positive optical axis direction of the objective lens 24, and the control current is applied to the radial tilt coil 43a such that the electromagnetic force is generated in the negative optical axis direction of the objective lens 24. Accordingly, the objective lens 24 attached at the movable section 34 may be rotationally driven about the radial tilt axis.

Incidentally, in the case of rotationally driving about the radial tilt axis, since the radial tilt coil 43a and the radial tilt coil 43b generate the moments in the same rotational direction, it is not necessary to care about the balance of the moments, and therefore, the asymmetric property in the shape, size, and location of the two radial tilt coils 43a and 43b would not be serious problems.

Similarly, in the case of transitionally driving in the tracking direction, the electromagnetic forces in the same direction (direction orthogonal to the radial tilt axis 203) act on the tracking coils 41a and 41b. Accordingly, the asymmetric property in the separations (locations) of the two tracking coils 41a and 41b relative to the radial tilt axis 203 would not be serious problems.

Preferably, the gap between each coil and each magnet facing to each other is as small as possible to effectively generate the electromagnetic force.

As described above, in the present embodiment, since the dense package is encouraged while the path of the light beam is secured, the asymmetric arrangement occurring accordingly is accepted, and correspondingly, the shape and the like of the coils and the magnets are arranged to be asymmetric, so that the moments including the electromagnetic forces are balanced to secure the dynamic balance.

The tracking coils 41a and 41b, the focus coils 42a and 42b, and the radial tilt coils 43a and 43b, may be formed with air-core-winding coils, or printed coil substrates (fine pattern coils).

(3) Configuration and Operation of Objective Lens Actuator (Part II)

FIG. 9 is a perspective view showing a configuration (fixture section) in which the movable section 34 and the suspension wires are removed from the objective lens actuator 10.

The yoke base 35 has a lower opening 35a provided in the bottom wall thereof, and a front opening 35b provided in the front side wall thereof.

The raising mirror 205 is disposed in the optical pickup (not shown) at a lower portion of the yoke base 35, for guiding the light beam 204 to the objective lens 24, and a part of the raising mirror 205 penetrates through the lower opening 35a and comes into the objective lens actuator 10.

FIG. 10 is an illustration showing a positional relationship among the objective lens 24, the raising mirror 205, the diffraction grating with the quarter-wave plate 22, and the light beam 204.

The light beam 204 input from the front of the objective lens actuator 10 is reflected by the raising mirror 205, passes through the diffraction grating with the quarter-wave plate 22 along the optical axis direction of the objective lens 24, and then is incident on the objective lens 24.

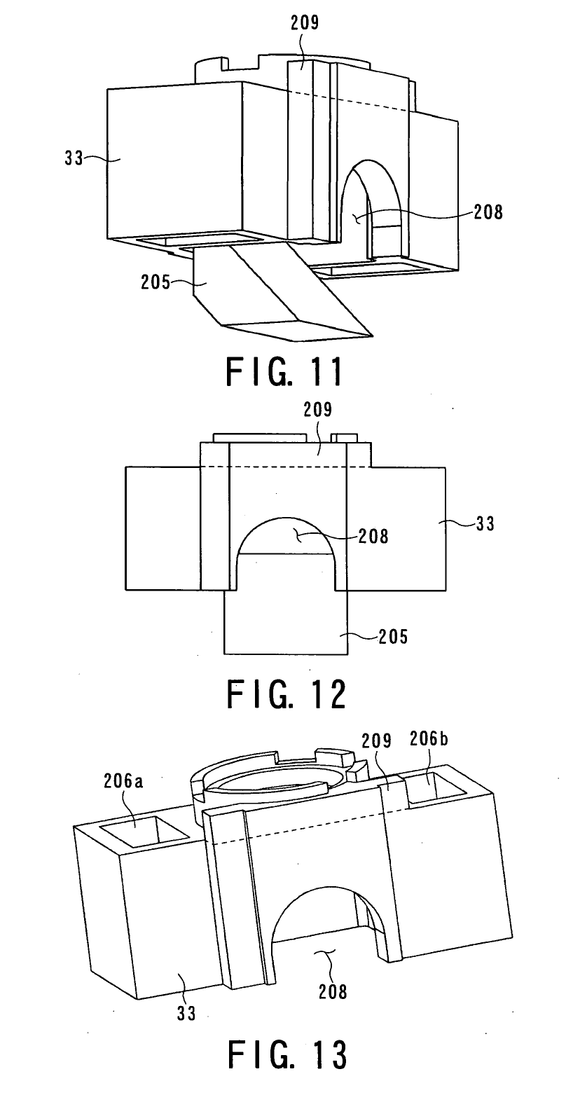

FIGS. 11 and 12 are illustrations each showing a positional relationship between the raising mirror 205 and the lens holder 33. The raising mirror 205 penetrates through the lower opening 35a of the yoke base 35, and then is housed in the lens holder 33. In addition, in order to guide the light beam 204 to the raising mirror 205, a semicircular cutout 208 is formed in the front side wall of the lens holder 33. As described above, since the part of the raising mirror 205 is housed in the lens holder 33, the objective lens actuator 10 and the optical pickup 50 may be formed thin together.

In addition, a reinforcing projection 209 is formed at the front side wall of the lens holder 33, at a position opposite to that of the semicircular cutout 208.

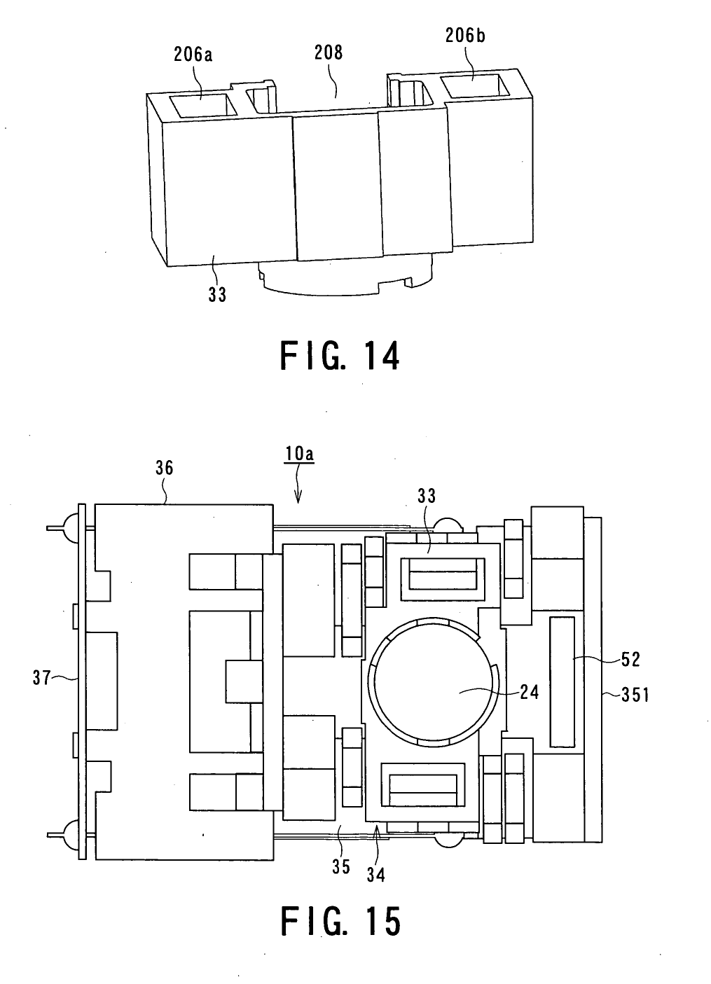

FIGS. 13 and 14 are illustrations each showing a specific structure of the lens holder 33. FIG. 13 is a perspective view showing the lens holder 33 viewed from the front, and FIG. 14 is a perspective view showing the lens holder 33 in a vertically reversed manner.

The lens holder 33 is made of a light and highly rigid material like engineering plastic, for example, liquid crystal polymer. The lens holder 33 is a substantially rectangular, three-hollow-box structure, and has two holes 206a and 206b formed at both sides in the tracking direction of the lens holder 33 with the objective lens 24 being interposed therebetween, so that magnetic yokes 207a and 207b penetrate through the holes 206a and 206b, respectively.

In addition, to make the structure thin, the part of the raising mirror 205 is housed in the lens holder 33, and the semicircular cutout 208 is provided at the front side wall of the lens holder 33 to guide the light beam 204 to the raising mirror 205.

The reinforcing projection 209 is provided for preventing the rigidity of the lens holder 33 in the radial tilt direction from being decreased due to the provision of the semicircular cutout 208.

To transfer data fast in an optical disc drive, a high-order resonance frequency at the movable section 34 must be increased, in addition to increase in thrust of the objective lens actuator 10. By using the lens holder 33 configured as described above, the high-order resonance frequency in the focus direction and in the tracking direction may be markedly increased.

The above-described objective lens actuator 10 may increase the thrust in all three axis directions, and also the thrusts of each of the focus coils 42a and 42b, and the radial tilt coils 43a and 43b may be arbitrarily set by properly modifying the thickness of each coil.

In addition, since the structure of the lens holder 33 of the objective lens 24 may be optimized to markedly increase the rigidity thereof, the extremely high-order resonance frequency may be applicable.

Accordingly, the optical disc drive may have high performance and high double-speed property, stand for the fast data transfer, and prevent the objective lens 24 from being inclined in the radial tilt direction even when the objective lens 24 is driven in the tracking direction. In addition, since the part of the raising mirror disposed in the optical pickup is disposed in the holder, the objective lens actuator 10 may be so thin that can be mounted on a notebook computer or the like.

### (4) SECOND EMBODIMENT

In the above-described objective lens actuator 10 according to the first embodiment, the collimator lens 52 that converts the laser light into the parallel light is not included in the configuration of the objective lens actuator 10. Alternatively, the collimator lens 52 may be included in the configuration of the objective lens actuator 10.

FIGS. 15, 16, and 17 are illustrations each showing an exemplary configuration of an embodiment (second embodiment) in which the collimator lens 52 is additionally applied to the objective lens actuator 10.

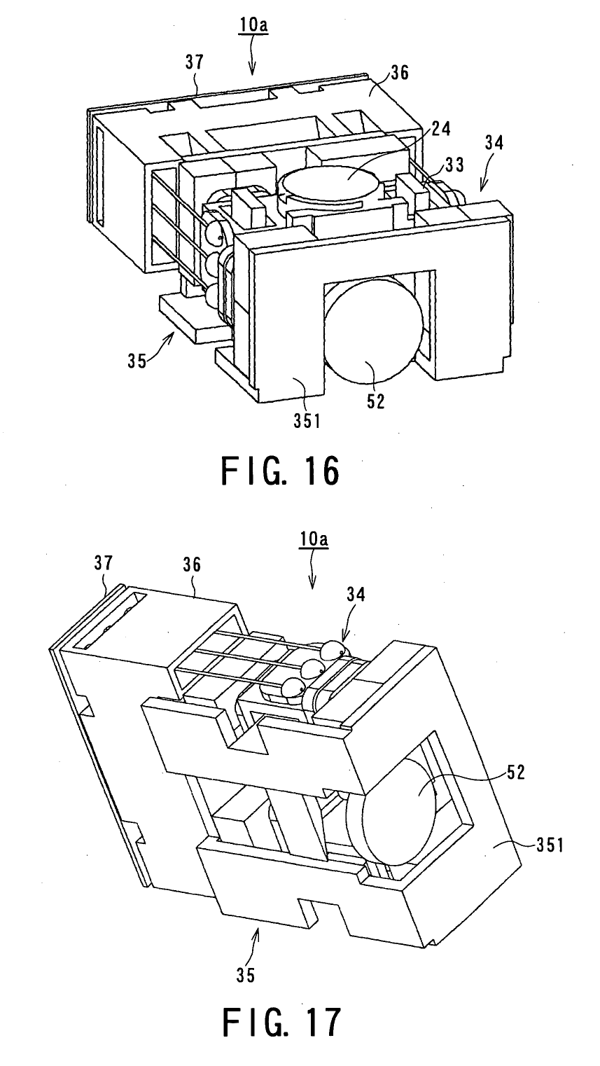

FIG. 15 is a plan view showing an objective lens actuator 10a provided with the collimator lens 52, FIG. 16 is a perspective view seen from the upper front, and FIG. 17 is a perspective view seen from the lower front.

In the objective lens actuator 10a according to the second embodiment, the collimator lens 52 is disposed in a space defined between a front side wall 351 of the yoke base 35 and the movable section 34. The light beam 204 passing through the collimator lens 52 is redirected due to the raising mirror 205, and incident on the objective lens 24. Meanwhile, the reflection light from the optical disc 200 that comes from the objective lens 24 is redirected due to the raising mirror 205, passes through the collimator lens 52, and then is output to the outside.

In the objective lens actuator 10a according to the second embodiment, since the collimator lens 52 is housed in the space in the objective lens actuator 10, the space may be highly effectively used in view of the whole optical pickup 50, and this may realize further dense package.

Incidentally, a liquid crystal element has been utilized in an optical disc drive for correcting spherical aberration, coma, or astigmatism, in recent years. Such a liquid crystal element may be additionally provided between the collimator lens 52 and the raising mirror 205.

It should be noted that the present invention is not limited to the above-described embodiments, and the components thereof may be modified and embodied within the scope of the present invention upon its implementation. In addition, the plurality of components disclosed in the above-described embodiments may be appropriately combined to form various configurations of the invention. For example, some of the components may be eliminated from the entire components shown in the embodiments.

In addition, in the embodiments, while the focus coils and the radial tilt coils are separately provided, two common coils (focus and radial tilt), which have both functions as the focus coil and the radial tilt coil, may be arranged to face the two focus magnets 45a and 45b, respectively, and may be disposed diagonally about the objective lens 24. In this case, the control in the radial tilt direction may be achieved according to the control by differentially driving the two common coils (focus and radial tilt).

What is claimed is:

1. An objective lens actuator capable of translational driving in a tracking direction, translational driving in a focus direction, and rotational driving about a radial tilt axis, comprising:
an objective lens for condensing laser light on an information-recording surface of an optical disc;
a lens holder shaped in a hollow, substantially rectangular parallelepiped, for fixing the objective lens at the center of an upper surface of the lens holder;
a pair of tracking coils, attached at lateral surfaces of the lens holder diagonally with the objective lens being interposed between the tracking coils, for translationally driving the lens holder in the tracking direction;
a pair of radial tilt coils, attached at the lateral surfaces of the lens holder at positions different from that of the tracking coils diagonally about the radial tilt axis with the objective lens being interposed between the radial tilt coils, for rotationally driving the lens holder about the radial tilt axis;
a pair of focus coils, superimposed and attached onto the radial tilt coils, for translationally driving the lens holder in the focus direction;
a pair of tracking magnets disposed so as to face the tracking coils;
a pair of focus magnets disposed so as to face the focus coils;
a fixture section at which the tracking magnets and the focus magnets are fixed; and
a suspension wire for holding the lens holder in the air, an end of the suspension wire being fixed at the fixture section and the other end thereof being fixed at the lens holder, wherein
the pair of the focus coils and the pair of the focus magnets, disposed with the radial tilt axis being interposed between the coils and between the magnets, are each asymmetric in at least one of shape, size, mass, and location, and each have balanced moments about the radial tilt axis.

2. The objective lens actuator according to claim 1, wherein each pair of the focus coils and focus magnets, which are disposed with the radial tilt axis being interposed between the coils and between the magnets, has the balanced moments about the radial tilt axis when the same current is applied to the pair of the focus coils.

3. The objective lens actuator according to claim 1, wherein the lens holder houses a part of a raising mirror for guiding the laser light input and output in a direction orthogonal to an optical axis of the objective lens to the optical axis, and has a semicircular cutout provided in one of side walls of the lens holder so that the input and output laser light passes through the semicircular cutout.

4. The objective lens actuator according to claim 3, wherein the lens holder has a reinforcing projection provided in the one of the side walls of the lens holder at a position opposite to that of the semicircular cutout.

5. The objective lens actuator according to claim 1, further comprising a collimator lens provided at an input/output opening for the laser light provided at the fixture section.

6. An objective lens actuator capable of translational driving in a tracking direction, translational driving in a focus direction, and rotational driving about a radial tilt axis, comprising:
an objective lens for condensing laser light on an information-recording surface of an optical disc;
a lens holder shaped in a hollow, substantially rectangular parallelepiped, for fixing the objective lens at the center of an upper surface of the lens holder;
a pair of tracking coils, attached at lateral surfaces of the lens holder diagonally with the objective lens being interposed between the tracking coils, for translationally driving the lens holder in the tracking direction;
a pair of focus and radial tilt coils, attached at the lateral surfaces of the lens holder at positions different from that of the tracking coils diagonally about the radial tilt axis with the objective lens being interposed between the focus and radial tilt coils, for rotationally driving the lens holder about the radial tilt axis and for translationally driving the lens holder in the focus direction;
a pair of tracking magnets disposed so as to face the tracking coils;
a pair of focus magnets disposed so as to face the focus and radial tilt coils;
a fixture section at which the tracking magnets and the focus magnets are fixed; and
a suspension wire for holding the lens holder in the air, an end of the suspension wire being fixed at the fixture section and the other end thereof being fixed at the lens holder, wherein
the pair of the focus and radial tilt coils and the pair of the focus magnets, disposed with the radial tilt axis being interposed between the coils and between the magnets, are each asymmetric in at least one of shape, size, mass, and location, and each have balanced moments about the radial tilt axis.

7. An information recording/playback apparatus, comprising:
an optical pickup having an objective lens actuator;
a drive controller that controls driving of the objective lens actuator;
a playback processor that performs a playback processing for a signal output from the optical pickup; and
a recording processor that modulates recording data into a laser control signal, and outputs the laser control signal to the optical pickup, wherein
the objective lens actuator capable of translational driving in a tracking direction, translational driving in a focus direction, and rotational driving about a radial tilt axis, includes:
an objective lens for condensing laser light on an information-recording surface of an optical disc;
a lens holder shaped in a hollow, substantially rectangular parallelepiped, for fixing the objective lens at the center of an upper surface of the lens holder;
a pair of tracking coils, attached at lateral surfaces of the lens holder diagonally with the objective lens being interposed between the tracking coils, for translationally driving the lens holder in the tracking direction;
a pair of radial tilt coils, attached at the lateral surfaces of the lens holder at positions different from that of the tracking coils diagonally about the radial tilt axis with the objective lens being interposed between the radial tilt coils, for rotationally driving the lens holder about the radial tilt axis;
a pair of focus coils, superimposed and attached to the radial tilt coils, for translationally driving the lens holder in the focus direction;
a pair of tracking magnets disposed so as to face the tracking coils;
a pair of focus magnets disposed so as to face the focus coils;
a fixture section at which the tracking magnets and the focus magnets are fixed; and a suspension wire for holding the lens holder in the air, an end of the suspension wire being fixed at the fixture section and the other end thereof being fixed at the lens holder, wherein
the pair of the focus coils and the pair of the focus magnets, disposed with the radial tilt axis being interposed between the coils and between the magnets, are each asymmetric in at least one of shape, size, mass, and location, and each have balanced moments about the radial tilt axis.

8. The information recording/playback apparatus according to claim 7, wherein each pair of the focus coils and focus magnets, which are disposed with the radial tilt axis being interposed between the coils and between the magnets, has the balanced moments about the radial tilt axis when the same current is applied to the pair of the focus coils.

9. The information recording/playback apparatus according to claim 7, further comprising a raising mirror disposed in the optical pickup for guiding the laser light input and output in a direction orthogonal to an optical axis of the objective lens to the optical axis, wherein
the lens holder houses a part of the raising mirror, and has a semicircular cutout provided in one of side walls of the lens holder so that the input and output laser light passes through the semicircular cutout.

10. The information recording/playback apparatus according to claim 9, wherein the lens holder has a reinforcing projection provided in the one of the side walls of the lens holder at a position opposite to that of the semicircular cutout.

11. The information recording/playback apparatus according to claim 7, further comprising a collimator lens provided at an input/output opening for the laser light provided at the fixture section.

12. An information recording/playback apparatus, comprising:
an optical pickup having an objective lens actuator;
a drive controller that controls driving of the objective lens actuator;
a playback processor that performs a playback processing for a signal output from the optical pickup; and a recording processor that modulates recording data into a laser control signal, and outputs the laser control signal to the optical pickup, wherein
the objective lens actuator capable of translational driving in a tracking direction, translational driving in a focus direction, and rotational driving about a radial tilt axis, includes:
an objective lens for condensing laser light on an information-recording surface of an optical disc;
a lens holder shaped in a hollow, substantially rectangular parallelepiped, for fixing the objective lens at the center of an upper surface of the lens holder;
a pair of tracking coils, attached at lateral surfaces of the lens holder diagonally with the objective lens being interposed therebetween, for translationally driving the lens holder in the tracking direction;
a pair of focus and radial tilt coils, attached at the lateral surfaces of the lens holder at positions different from that of the tracking coils diagonally about the radial tilt axis with the objective lens being interposed between the focus and radial tilt coils, for rotationally driving the lens holder about the radial tilt axis and for translationally driving the lens holder in the focus direction;
a pair of tracking magnets disposed so as to face the tracking coils;
a pair of focus magnets disposed so as to face the focus and radial tilt coils;
a fixture section at which the tracking magnets and the focus magnets are fixed; and
a suspension wire for holding the lens holder in the air, an end of the suspension wire being fixed at the fixture section and the other end thereof being fixed at the lens holder, wherein
the pair of the focus and the radial tilt coils and the pair of the focus magnets, disposed with the radial tilt axis being interposed between the coils and between the magnets, are each asymmetric in at least one of shape, size, mass, and location, and each have balanced moments about the radial tilt axis.
